(19) United States
(12) Patent Application Publication
(10) Pub. No.: US 2026/0346691 A1
(43) Pub. Date: Nov. 5, 2026

(54) HIDDEN SEAL FOR VEHICLE WINDOW WITH MOVABLE GLASS

(71) Applicant: Rivian IP Holdings, LLC, Irvine, CA (US)

(72) Inventor: David Tobon, Northville, MI (US)

(21) Appl. No.: 19/198,886

(22) Filed: May 5, 2025

(51) Int. Cl. B60J 10/70; B29C 45/16; B29L 31/26; B60J 10/27; B60J 10/33; F16J 15/3204

(52) U.S. Cl. CPC B60J 10/70; B29C 45/1635; B29C 45/1676; B60J 10/27; B60J 10/33; F16J 15/3204; B29L 2031/26

(57) ABSTRACT

A window seal includes a molded shape having a first section configured to extend along an edge of a window, a second section configured to extend along the edge of the window, and a middle section arranged between the first section and the second section and offset from the first section and the second section towards the edge of the window. The window seal may be molded to follow a relatively complex path, and may include retaining features for installation in a vehicle.

### INTRODUCTION

The present disclosure is directed to a hidden outer belt seal for a liftgate window that follows a path having transitions.

### SUMMARY

In some embodiments, the present disclosure is directed to an apparatus that includes a window seal having a molded shape. In some embodiments, the molded shape includes a first section configured to extend along an edge of a window, a second section configured to extend along the edge of the window, and a middle section arranged between the first section and the second section and offset from the first section and the second section towards the edge of the window. For example, in some embodiments, the middle section includes a first transition that interfaces with a first end of the first section and curves away from the first end to offset the middle section, and a second transition that interfaces with a second end of the second section and curves away from the second end to offset the middle section. In some embodiments, the window seal is a one-piece seal, and the middle section is offset from the first and second sections to accommodate a component arranged in-line with the first section and the second section. In some embodiments, for example, the molded shape is formed as a single continuous piece using injection molding. To illustrate, 2k-shot molding may be used, wherein more than one material may be provided to the mold. In some embodiments, a path extends along the edge of the window along an outside surface of the window, the curvature of the path is only one of straight, convex, or concave, where the first section and the second section are aligned with the path and the middle section is offset from the path.

In some embodiments, the window seal includes a hook-shaped cross-section configured to interface to a retainer, and the window seal includes one or more retaining features configured to secure the window seal to the retainer. In some embodiments, the one or more retaining features include at least one first retaining feature arranged at a first end of the hook-shaped cross-section, and at least one second retaining feature arranged at a second end of the hook-shaped cross-section. In some embodiments, the one or more retaining features include a plurality of first retaining features distributed along the first section, the middle section, and the second section, as well as a plurality of second retaining features distributed along the first section, the middle section, and the second section.

In some embodiments, the window seal includes a first material forming a hook-shaped cross-section having a first wall that extends in a first direction, a second wall extending laterally from an end of the first wall, and a third wall that extends in a second direction opposite the first direction from the second wall. For example, the second wall extends between the first wall and the third wall. In some embodiments, the window seal includes a first lip having a second material extending outward from the first wall and configured to seal against the window, as well as a second lip having the second material extending outward from the second wall and configured to seal against a structure. For example, in some embodiments, the window seal includes a plurality of first retaining features of the first material and extending inward from an end of the third wall to engage a retainer to secure the window seal to the retainer. In a further example, the window seal may also include a plurality of second retaining features of the first material and extending inward from another end of the first wall to engage the retainer to secure the window seal to the retainer. For example, the plurality of first retaining features and the plurality of second retaining features may be formed as one-piece of the molded shape. In some embodiments, the plurality of first retaining features and the plurality of second retaining features are distributed along the first section, the middle section, and the second section.

In some embodiments, the present disclosure is directed to a window seal having a one-piece body. The one-piece body includes a first section having a first inner end, a second section having a second inner end, and a middle section arranged between the first section and the second section and at an offset from the first section and the second section. In some embodiments, the middle section includes a first transition coupled to the first inner end, and a second transition coupled to the second inner end. For example, the first transition and the second transition are shaped to form the offset. In some embodiments, the one-piece body includes a plurality of retaining features configured to secure the window seal to a vehicle. In some embodiments, the one-piece body includes a hook-shaped cross-section of a first material, a first lip of a second material more flexible than the first material extending outward from the hook-shaped cross section and configured to seal against the window. In some embodiments, the one-piece body includes a second lip also of the second material and extending outward from the hook-shaped cross section to seal against a structure.

In some embodiments, the present disclosure is directed to an assembly having a retainer and a window seal. In some embodiments, the retainer includes an opening configured to interface to a window of a vehicle. In some embodiments, the retainer is configured to extend only around a portion of a periphery of a window. In some embodiments, the window seal extends along a path. In some embodiments, the window seal includes a molded shape having a first section configured to extend along an edge of the retainer, a second section configured to extend along the edge of the retainer, and a middle section arranged between the first section and the second section and offset outward from the first section and the second section. In some embodiments, the retainer is configured to accommodate a wiper assembly, the first section and the second section are arranged on opposite ends of the wiper assembly, and the middle section is offset around the wiper assembly. In some embodiments, the middle section includes a first transition that interfaces with the first section and extends from the first section to an offset distance, and a second transition that interfaces with the second section and extends from the second section to the offset distance. In some embodiments, the window seal includes a plurality of retaining features configured to secure the window seal to the retainer. In some embodiments, the window seal includes a hook-shaped cross-section of a first material. In some embodiments, the window seal includes a first lip of a second material more flexible than the first material extending outward from the hook-shaped cross-section and configured to seal against the window. In some embodiments, the window seal also includes a second lip of the second material extending outward from the hook-shaped cross-section and configured to seal against a structure.

### BRIEF DESCRIPTION OF THE DRAWINGS

The present disclosure, in accordance with one or more various embodiments, is described in detail with reference to the following figures. The drawings are provided for purposes of illustration only and merely depict illustrative embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a side view of an illustrative vehicle having a liftgate, in accordance with some embodiments of the present disclosure;

FIG. 2 shows a rear view of a portion of the illustrative vehicle of FIG. 1, in accordance with some embodiments of the present disclosure;

FIG. 3 shows a cross-sectional view of a portion of a liftgate having a hidden wiper, in accordance with some embodiments of the present disclosure;

FIG. 4 shows a perspective view of an illustrative seal, in accordance with some embodiments of the present disclosure;

FIG. 5 shows a perspective view of another illustrative seal, in accordance with some embodiments of the present disclosure;

FIG. 6 shows a perspective view of the illustrative seal of FIG. 4 with several cross-sections, in accordance with some embodiments of the present disclosure;

FIG. 7-8 show two perspective cross-sectional views of the illustrative seal of FIG. 6 having retaining features engaged with a structure, in accordance with some embodiments of the present disclosure;

FIG. 9-11 show three perspective cross-sectional views of the illustrative seal of FIG. 5 having retaining features engaged with a structure, in accordance with some embodiments of the present disclosure;

FIG. 12 shows a perspective view of an illustrative retainer and seal, in accordance with some embodiments of the present disclosure;

FIG. 13-14 show a side cross-sectional view of an assembly at two positions along a seal, in accordance with some embodiments of the present disclosure; and

FIG. 15 is a flowchart of an illustrative process for making and installing a seal, in accordance with some embodiments of the present disclosure.

### DETAILED DESCRIPTION

In some embodiments, the present disclosure is directed to an outer belt seal for a vehicle window that follows a complex path. For example, because the path of the seal is not necessarily linear, the seal might not be readily extrudable. Accordingly, in some embodiments, the present disclosure is directed to a moldable seal that follows a non-straight path. Rather than form separate extrusions and transitions to piece together the seal, a seal may be molded as one-piece (e.g., using 2K-shot molding of two materials, or any other suitable approach). Retention features may be integrated into the seal (e.g., formed during molding of the same material as the seal body). As an example, a first material may be molded to form the seal body, and then a second material may be molded onto the body to form extensions (e.g., lips that seal against the window or other surfaces). Because the resulting seal is one-piece, it may be less costly to manufacture while still accommodating the non-straight seal path.

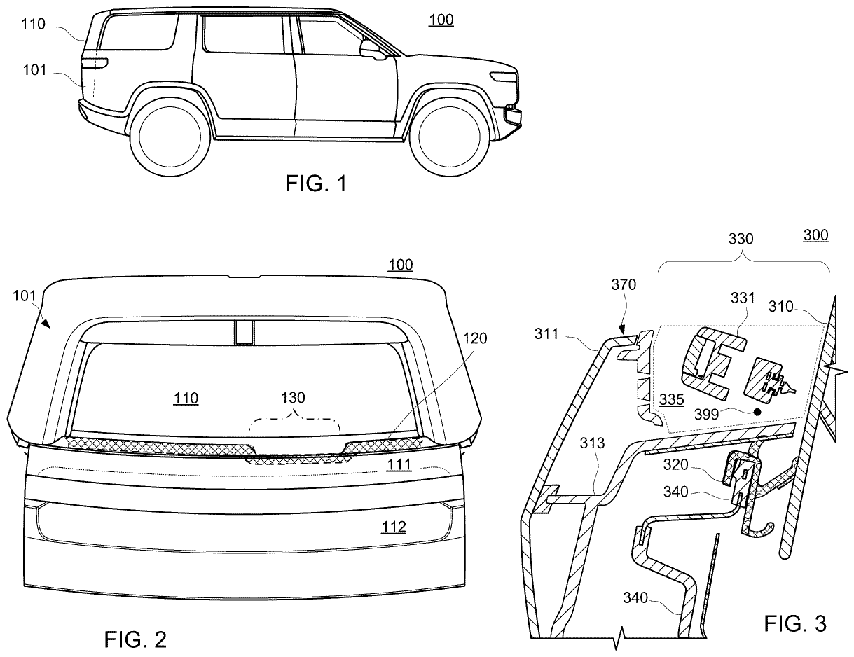

FIG. 1 shows a side view of illustrative vehicle 100 having liftgate 101, in accordance with some embodiments of the present disclosure. Liftgate 101 includes window 110, which may be movable. For example, liftgate 101 may be configured to be opened and closed, and window 110 may be configured to be raised and lowered as part of liftgate 101. The seals of the present disclosure may be applicable, in some embodiments, to movable windows of a liftgate. In some embodiments, the seals of the present disclosure are appliable to any suitable movable window of a vehicle. For example, any vehicle window may include seals at one or more edges, and one or more of the seals may follow a path having a jog or offset that would be challenging to extrude as a single piece. Accordingly, the present disclosure may be applied to any suitable seal that follows an irregular, compound, offset, jogged, or otherwise complex path. Additionally, the present disclosure may also be applied to seals following relatively more simple paths. To illustrate, because the seals of the present disclosure may be molded, they may follow any suitable path. To illustrate, in some embodiments, the present disclosure is directed to an outer belt seal for a vehicle liftgate window such as window 110. Liftgate 101 may include a movable glass system having a hidden wiper and a hidden seal that follows a complex path around the wiper. For example, the hidden wiper creates a “tub” where the wiper arranged. The tub causes the path of the seal to juggle though a “U” shape as the seal follows the edge of the window and around the wiper tub.

FIG. 2 shows a rear view of a portion of illustrative vehicle 100 of FIG. 1, in accordance with some embodiments of the present disclosure. As illustrated, liftgate 101 includes window 110, body panels 111 and 112 (e.g., defining at least part of a vehicle exterior), seal 120, and wiper tub 130. To illustrate, a wiper assembly for clearing at least a portion of window 110 may be housed in wiper tub 130. In some embodiments, as illustrated, seal 120 may be hidden (e.g., arranged behind or within body panel 111 such that seal 120 is not generally visible from the exterior of vehicle 100). In some embodiments, as illustrated, wiper tub 130 may be at least partially hidden (e.g., arranged behind or within body panel 111 such that most or all of wiper tub 130 is not generally visible from the exterior of vehicle 100). While illustrated at being arranged along a bottom edge of window 110, a hidden seal such as seal 120 may be installed along any, or every, edge of a window of a vehicle. For example, the sealing edges along the sides and top of window 110 may be relatively simple (e., straight, convex, or concave), the bottom edge may require that seal 120 jog around wiper tub 130. Accordingly, as illustrated, seal 120 generally follows a relatively simple path along the bottom edge of window 110, but is offset from the path along a section corresponding to wiper tub 130. Thus, as illustrated, the actual path includes an offset to jog around wiper tub 130.

FIG. 3 shows a cross-sectional view of a portion of liftgate 300 having wiper 331 (e.g., a hidden wiper recessed behind body panel 311), in accordance with some embodiments of the present disclosure. As illustrated, liftgate 300 includes window 310, wiper 331 arranged in recess 335, body panel 311, structure 313, retainer 340, and seal 320. Recess 335 forms a wiper tub (e.g., similar to wiper tub 130 of FIGS. 1-2), in which wiper 331 is arranged and hidden at least part from view outside of body panel 311. Wiper 331 may include a wiper blade, an arm, an electric motor, a linkage, a washer nozzle, any other suitable components, or any combination thereof, and may be configured to clean the exterior surface of window 310. Because wiper 331 is recessed below top 370 of body panel 311, seal 320 may need to be offset lower in the region corresponding to wiper 331 to extend around recess 335. For example, seal 320 may follow a path approximately just below top 370 (e.g., to be hidden, at about location 399) for some of its length, and then extend around recess 335 in the region of the window corresponding to wiper 331. While illustrated as extending around recess 335, a seal such as seal 320 may be configured to follow any relatively complex path, around any suitable components, features, or combinations thereof. As illustrated, seal 120 is configured to seal against window 310 and structure 313. For example, seal 320 may interface with retainer 340, which may in turn be affixed to structure 313, to which body panel 311 may also be affixed. Structure 313 may also generally follow the edge of window 310 and include a jog to form recess 335.

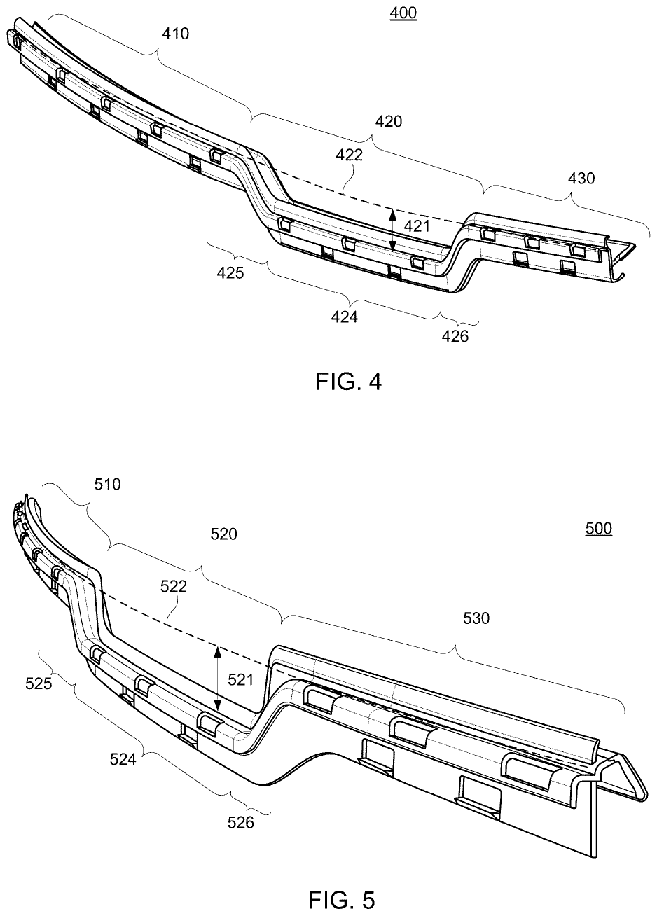

FIG. 4 shows a perspective view of illustrative seal 400, in accordance with some embodiments of the present disclosure. As illustrated, seal 400 includes sections 410, 420, and 430. Sections 410 and 420, at the axial ends of seal 400, generally lie along path 422, which may extend along an edge (e.g., and be suitably inset from the edge) of a window. Section 420 (e.g., middle portion 424 thereof) is offset by an offset distance 421 from path 422. Because section 420 is offset, seal 400 may be able to seal around an obstacle that would otherwise interfere with path 422. In an illustrative example, path 422 may be convex (e.g., relative to being installed at the bottom region of window), although seal 400 may include a more complex shape to accommodate the offset distance 421. For example, seal 400 may be convex along sections 410 and 430 and middle portion 424 of section 420, but achieve concavity along transitions 425 and 426 (e.g., the S-shaped portions between middle portion 424 and sections 410 and 430). A seal may include any suitable number of offsets, changes in concavity, changes in radius of curvature, transitions among sections, transitions from straight to curved sections, any other suitable aspects of shape, or any combination thereof. To illustrate, a path may extend along the edge of the window along an outside surface of the window (e.g., as illustrated by path 422). In an illustrative example, the curvature of the path may include only one of straight, convex, or concave path, where the first section and the second section are aligned with the path (e.g., sections 410 and 430 are aligned with path 422) and the middle section is offset from the path (e.g., section 420 is offset by offset distance 421 from path 422).

In an illustrative example, seal 400 includes a molded shape having a first section (e.g., section 410) configured to extend along an edge of a window, a second section (e.g., section 430) configured to extend along the edge of the window, and a middle section (e.g., section 420) arranged between the first section and the second section and offset from the first section and the second section (e.g., by offset distance 421) towards the edge of the window (e.g., when installed). For example, the middle section (e.g., section 420) may include a first transition (e.g., transition 425) that interfaces with a first end of the first section and curves away from the first end to offset the middle section (e.g., middle portion is arranged away from path 422). Further, the middle section (e.g., section 420) may include a second transition (e.g., transition 425) that interfaces with a second end of the second section and curves away from the second end to offset the middle section.

FIG. 5 shows a perspective view of illustrative seal 500, in accordance with some embodiments of the present disclosure. As illustrated, seal 500 includes sections 510, 520, and 530. Sections 510 and 520, at the axial ends of seal 500, generally lie along path 522, which may extend along an edge (e.g., and be suitably inset from the edge) of a window. Section 520 (e.g., middle portion 524 thereof) is offset by an offset distance 521 from path 522. Because section 520 is offset, seal 500 may be able to seal around an obstacle that would otherwise interfere with path 522. In an illustrative example, path 522 may be convex (e.g., relative to being installed at the bottom region of window), although seal 500 may include a more complex shape to accommodate the offset distance 521. For example, seal 500 may be convex along sections 510 and 530 and middle portion 424 of section 420, but achieve concavity along transitions 525 and 525 (e.g., the S-shaped portions between middle portion 524 and sections 510 and 530). A seal may include any suitable number of offsets, changes in concavity, changes in radius of curvature, transitions among sections, transitions from straight to curved sections, any other suitable aspects of shape, or any combination thereof.

In an illustrative example, a window seal such as a hidden outerbelt seal may be installed to avoid being visible from the vehicle exterior. While seals having the shape of seals 400 and 500 may be made from three extrusion pieces (e.g., for the sections excluding the transitions), having different seal profiles, and then joined using a molded portion (e.g., including a thermoplastic vulcanize (TPV) material for compliance), seals 400 and 500 are each one-piece, with embedded retention features to be more cost effective.

FIG. 6 shows a perspective view of illustrative seal 400 of FIG. 4 with several cross-sections, in accordance with some embodiments of the present disclosure. As illustrated, cross-sectional view 690 is taken from section 410, cross-sectional view 691 is taken from section 420, and cross-sectional view 692 is taken from section 430. The openings along seal 400 may be included due to the presence of pluralities of retaining features 611 and 612 (e.g., pluralities of first and second retaining features). For example, during a molding process, because retaining features extend laterally (e.g., for a vertical drafting direction based on the cross-sectional views of FIG. 6), sliders used to form retaining features may need to be removed via openings 630 and 631. It will be understood that a seal may be formed in accordance with the present disclosure without openings for sliders, or with any suitable number of openings for any suitable number of sliders, and may be formed using any suitable molding process (e.g., having any suitable drafting direction). It will also be understood that for the orientation of cross-sectional views 690-692, directions and relative positions may be referred to (e.g., up, down, below, above, vertical, lateral, horizontal), which may change if the orientation changes. For example, because a seal may be arranged along any suitable edge of any suitable window, the relative positions may accordingly depend on the orientation of the seal as viewed, as installed, as illustrated, or as referred to (e.g., based on a suitable reference).

As illustrated, seal 400 includes seal body 610 having three walls (e.g., walls 650, 651, and 652, as indicated in cross-sectional view 691), which define a hook-shaped structure. For example, in some embodiments, seal 400 is a one-piece seal having a middle section (e.g., section 420) that is offset from two other sections (e.g., a first section and second section such as sections 410 and 430) to accommodate a component arranged in-line with the first section and the second section. In a further example, seal 400 may include a molded shape (e.g., forming the hook-shaped structure) formed as a single continuous piece using injection molding. It will be understood that body as used herein may include, for example, the hook-shaped structure and any or all of retaining features, extensions or lips, openings, and material that may be added to an extension. For example, a seal may be a one-piece body that may include seal body 610, pluralities of retaining features 611 and 612, and extensions 621-623 (e.g., which may be formed using process 1500). In a further example, seal body 610 may be part of a larger body that includes retaining features and extensions which may be molded together along a length of seal body 610.

As illustrated, seal 400 also includes extensions 621, 622, and 623 that extend outward from the hook-shaped structure of seal body 610. Extensions 621, 622, and 623 may be configured to seal against other structures or components of the vehicle, and accordingly may be configured to flex, stretch, or otherwise deform to follow another surface, when installed. In some embodiments, as illustrated, material 624 may be included on one or more extensions to create a desired interface. For example, material 624 may be arranged to interface to the window when installed, such that the window can glide along material 624 as it moves without incurring large friction forces, while maintaining a seal.

A plurality of openings 630, as shown in cross-sectional view 690, are arranged along sections 410, 420, and 430 of seal 400 (e.g., along the length of seal body 610), each of openings 630 corresponding to a retaining feature of plurality of retaining features 611. Retaining features 611 are configured to engage with a structure of the vehicle to secure seal 400 in place when installed. A plurality of openings 631, as shown in cross-sectional view 692, are arranged along sections 410, 420, and 430 of seal 400 (e.g., along the length of seal body 610), each of openings 631 corresponding to a retaining feature of plurality of retaining features 612. Retaining features 612 are configured to engage with a structure of the vehicle to secure seal 400 in place when installed. For example, retainers (e.g., pluralities of retaining features 611 and 612) may be configured to engage with the opposite sides of a structure that extends into the central recess of the hook-shaped structure (e.g., in the cross-sectional views illustrated, laterally between walls 650 and 652 and below wall 651). In a further example, plurality of retaining features 611 and plurality of retaining features 612 may each include a tab extending from the hook-shaped structure to catch with a mating feature of a structure of the vehicle. Because plurality of retaining features 611 and plurality of retaining features 612 are integrated as part of seal 400, additional parts or clips need not be used to secure seal 400 when installing in a vehicle.

In an illustrative example, as illustrated by cross-sectional views 690-692, the cross-section of seal 400 may be approximately similar along its length, as it follows a path having an offset (e.g., as illustrated in FIG. 4). For example, because seal 400 is formed to follow the path having an offset, a single material may be used to form seal body 610, without needing separately formed transition sections, adhesives, or seams arranged along the length of seal 400.

In another illustrative example, a window seal (e.g., seal 400) includes a hook-shaped cross-section (e.g., of seal body 610) configured to interface to a retainer (e.g., structure 701), and one or more retaining features (e.g., plurality of retaining features 611, 612, or both) configured to secure the window seal to the retainer. For example, the one or more retaining features may include at least one first retaining feature (e.g., of plurality of retaining features 611 or 612) arranged at a first end of the hook-shaped cross-section, and at least one second retaining feature (e.g., of plurality of retaining features 612 or 611) arranged at a second end of the hook-shaped cross-section. In a further example, the one or more retaining features may include a plurality of first retaining features (e.g., plurality of retaining features 611 or 612) distributed along the first section, the middle section, and the second section (e.g., sections 410, 420, and 430), as well as a plurality of second retaining features (e.g., plurality of retaining features 612 or 611) distributed along the first section, the middle section, and the second section (e.g., sections 410, 420, and 430). To illustrate, the window seal may include a plurality of first retaining features (e.g., plurality of retaining features 611 or 612) of the first material and extending inward from an end of the third wall (e.g., wall 650 or 652) to engage a retainer (e.g., structure 701) to secure the window seal to the retainer. Further, the window seal may also include a plurality of second retaining features (e.g., plurality of retaining features 612 or 611) also of the first material and extending inward from another end of the first wall (e.g., terminal end of wall 652 or 650) to engage the retainer to secure the window seal to the retainer. For example, the plurality of first retaining features and the plurality of second retaining features (e.g., pluralities of retaining features 612 and 611) may be distributed along the first section, the middle section, and the second section (e.g., sections 410, 420, and 430).

In another illustrative example, a window seal (e.g., seal 400) may include a first material that forms a hook-shaped cross-section having a first wall that extends in a first direction (e.g., wall 652 or wall 650), a second wall (e.g., wall 651) extending laterally from an end of the first wall, and a third wall (e.g., wall 650 or wall 652) that extends in a second direction opposite the first direction from the second wall, wherein the second wall extends between the first wall and the third wall. In some embodiments, a window seal (e.g., seal 400) may include a first lip of a second material (e.g., extension 621) extending outward from the first wall (e.g., wall 650) and configured to seal against the window. In some such embodiments, the window seal may also include a second lip of the second material (e.g., extension 622) extending outward from the second wall (e.g., wall 651) and configured to seal against a structure (e.g., as illustrated in FIGS. 13-14).

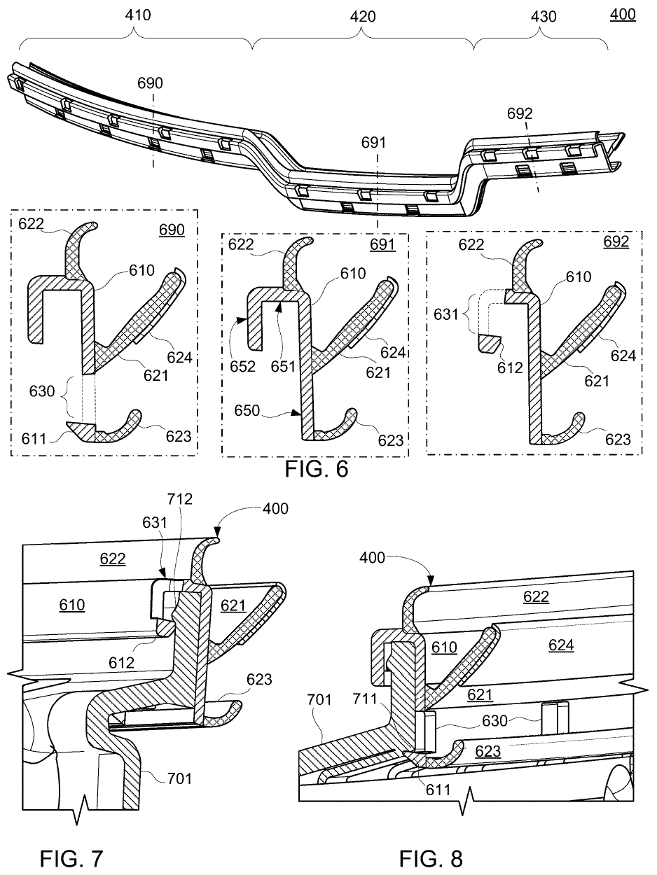

FIG. 7-8 show two perspective cross-sectional views of illustrative seal 600 of FIG. 6 having retaining features engaged with structure 701, in accordance with some embodiments of the present disclosure. As shown in FIG. 7, a retaining feature of plurality of retaining features 612 is engaged with structure 701 such that seal 400 is secured to structure 701. Structure 701 may include metal, plastic, any other suitable material, or any combination thereof (e.g., a composite), and may be also referred to as a retainer. For example, because plurality of retaining features 611 and plurality of retaining features 612 engage opposite sides of an extension of structure 701, seal 400 is retained against structure 701 and remains in place, when installed. For example, structure 701 includes features 711 and 712 (e.g., reciprocal or mating to plurality of retaining features 611 and plurality of retaining features 612) such that seal 400 and structure 701 are engaged, when seal 400 is installed.

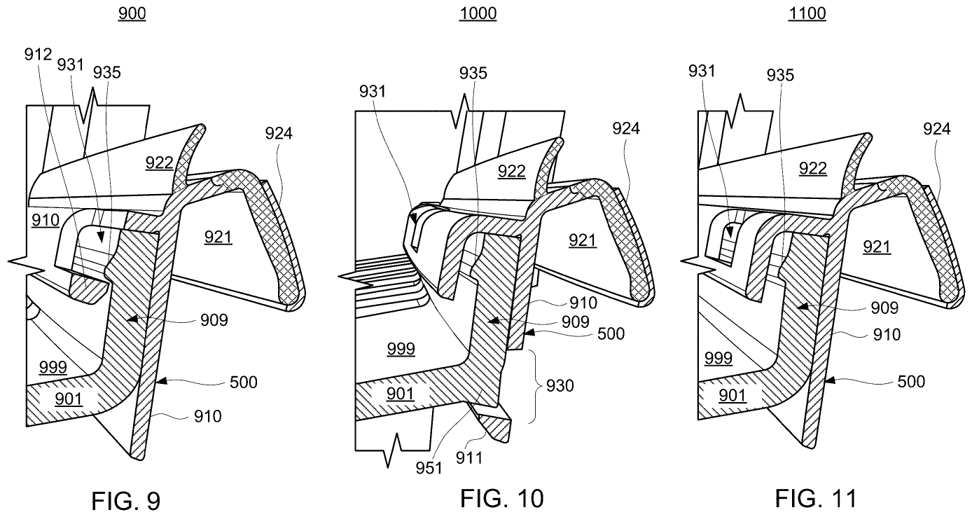

FIG. 9-11 show three perspective cross-sectional views of illustrative seal 500 of FIG. 5 having retaining features engaged with structure 901, in accordance with some embodiments of the present disclosure.

As illustrated, cross-sectional view 900 of FIG. 9 is taken in section 510, cross-sectional view 1000 of FIG. 10 is taken in section 520, and cross-sectional view 1100 is taken in section 530. Openings 930 and 931 along seal 500 may be included due to the presence of retaining features 911 and 912. For example, during a molding process, because retaining features extend laterally (e.g., for a vertical drafting direction based on the cross-sectional views of FIGS. 9-11), sliders used to form retaining features may need to be removed via openings 930 and 931. It will be understood that a seal may be formed in accordance with the present disclosure without openings for sliders, or with any suitable number of openings for any suitable number of sliders, and may be formed using any suitable molding process (e.g., having any suitable drafting direction). It will also be understood that for the orientation of cross-sectional views 900, 1000, and 1100, directions and relative positions may be referred to (e.g., up, down, below, above, vertical, lateral, horizontal), which may change if the orientation changes. For example, because a seal may be arranged along any suitable edge of any suitable window, the relative positions may accordingly depend on the orientation of the seal as viewed, as installed, as illustrated, or as referred to (e.g., based on a suitable reference).

As illustrated, seal 500 includes seal body 910 having a hook-shaped structure. Seal 500 also includes extensions 921 and 922 that extend outward from the hook-shaped structure of seal body 910. Extensions 921 and 922 may be configured to seal against other structures or components of the vehicle, and accordingly may be configured to flex, stretch, or otherwise deform to follow another surface, when installed. In some embodiments, as illustrated, material 924 may be included on one or more extensions to create a desired interface. For example, material 924 may be arranged to interface to the window when installed, such that the window can glide along material 924 as it moves without incurring large friction forces, while maintaining a seal.

A plurality of openings 930 are arranged along sections 510, 520, and 530 of seal 500 (e.g., along the length of seal body 910), each of openings 930 corresponding to a retaining feature of plurality of retaining features 911. Retaining features 911 are configured to engage with a structure of the vehicle (e.g., feature 951 of flange 909 of structure 901, which may be referred to as a retainer) to secure seal 500 in place when installed. A plurality of openings 931, are arranged along sections 510, 520, and 530 of seal 500 (e.g., along the length of seal body 910), each of openings 931 corresponding to a retaining feature of plurality of retaining features 912. Retaining features 912 are configured to engage with a structure of the vehicle (e.g., feature 935 of flange 909 of structure 901) to secure seal 500 in place when installed. For example, retainers (e.g., pluralities of retaining features 911 and 912) may be configured to engage with the opposite sides of a structure that extends into the central recess of the hook-shaped structure of seal body 910. In a further example, plurality of retaining features 911 and plurality of retaining features 912 may each include a tab extending from the hook-shaped structure to catch with a mating feature of a structure of the vehicle (e.g., features 935 and 951). Because plurality of retaining features 911 and plurality of retaining features 912 are integrated as part of seal 500, additional parts or clips need not be used to secure seal 500 when installing in a vehicle. As illustrated, structure 901 includes flange 909, which is oriented nearly vertically as illustrated, and configured to interface with seal 500 (e.g., by fitting in the recess of the hook-shaped structure).

In an illustrative example, the cross-sectional shape of seal 500 may be approximately similar along its length, as it follows a path having an offset (e.g., as illustrated in FIG. 5). For example, because seal 500 is formed to follow the path having an offset, a single material may be used to form seal body 910, without needing separately formed transition sections, adhesives, or seams arranged along the length of seal 500.

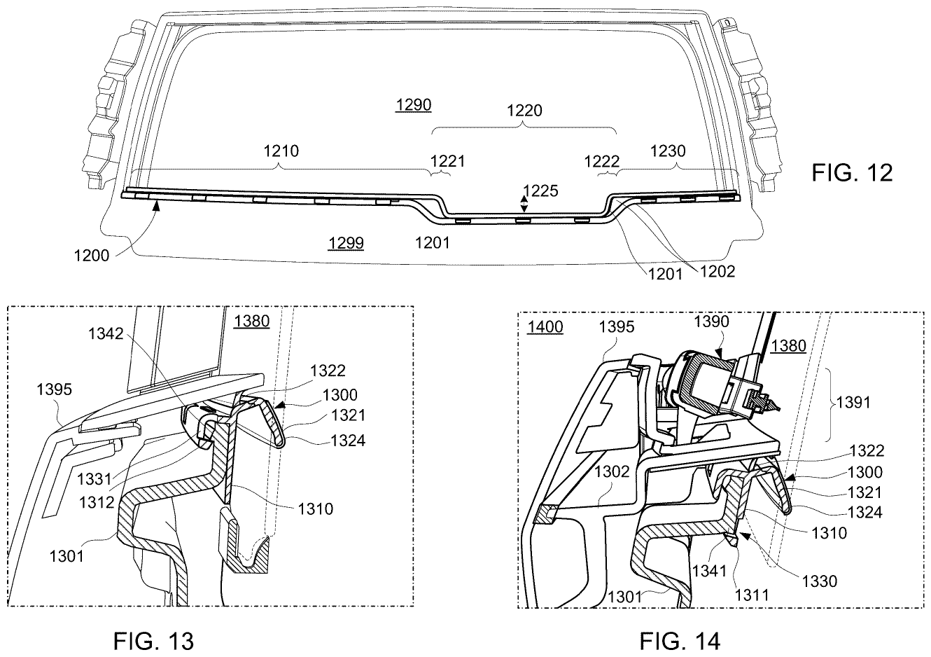

FIG. 12 shows a perspective view of illustrative retainer 1299 and seal 1200, in accordance with some embodiments of the present disclosure. Retainer 1299 includes a perimeter region extending around a central window recess (e.g., recess 1290), which is configured to border a moveable window when installed in a vehicle. For example, retainer 1299 may be secured to a vehicle structure (e.g., a door, liftgate, or other structure). Because retainer 1299 may interface to a window, seal 1200 is configured to seal against the window to prevent leaks and maintain the environment inside the vehicle. As illustrated, seal 1200 is arranged on a bottom side of recess 1290, such that as the window moves down (e.g., to open the window), the seal is maintained against the window. Seal 1200, as illustrated, includes sections 1210, 1220, and 1230, which all have similar curvatures, and transition sections 1221 and 1222 which connect sections 1210 and 1220 and sections 1220 and 1230, respectively. As shown in FIG. 12, lip 1201 and body 1202 of seal 1200 are visible. Seal 1200 may include additional lips that extend from body 1202 (e.g., similar to seals 400 and 500 of FIG. 4-5). In some embodiments, a seal may extend completely around a window recess (e.g., such as recess 1290), and may be molded in one-piece or multiple pieces (e.g., with at least one following a complex path). For example, section 1220 and transition sections (or “transitions”) 1221 and 1222 are configured to accommodate an obstacle in the otherwise simple path (e.g., along which sections 1210 and 1230 are arranged). Accordingly, section 1220 and transition sections 1221 and 1222 provide an offset distance to extend around the obstacle (e.g., a window wiper assembly) while maintaining a seal against the window (e.g., in any position of the window, lowered or raised).

FIGS. 13-14 show a side cross-sectional view of an assembly at two positions along a seal, in accordance with some embodiments of the present disclosure. The cross-sectional view of FIG. 13 illustrates seal 1300, retainer 1301, vehicle exterior 1395, and vehicle structure 1302. As illustrated, seal 1300 includes seal body 1310 defining a hook-shaped structure, for example. Seal 1300 also includes extensions 1321 and 1322 (e.g., lips) that extend outward from the hook-shaped structure of seal body 1310. Extension 1321 is configured to seal against, for example, window 1380, and accordingly may be configured to flex, stretch, or otherwise deform to maintain a seal against window 1380, when installed. Extension 1322 is configured to seal against, for example, vehicle structure 1302, and accordingly may be configured to flex, stretch, or otherwise deform to maintain a seal against vehicle structure 1302, when installed. In some embodiments, as illustrated, material 1324 may be included on one or more extensions to create a desired interface. For example, material 1324 may be arranged to interface to window 1380 when installed, such that window 1380 can glide along material 1324 as it moves without incurring large friction forces, while maintaining a seal.

As illustrated, a plurality of openings 1330 arranged along seal 1300 (e.g., along the length of seal body 1310), each corresponding to a retaining feature of plurality of retaining features 1311. Retaining features 1311 are configured to engage with retainer 1301 of the vehicle to secure seal 1300 in place when installed. Another plurality of openings 1331 is arranged along seal 1300 (e.g., along the length of seal body 1310), each corresponding to a retaining feature of plurality of retaining features 1312. Retaining features 1312 are configured to engage with retainer 1301 of the vehicle to secure seal 1300 in place when installed. For example, pluralities of retaining features 1311 and 1312 may be configured to engage with the opposite sides of a structure (e.g., retainer 1301 or another structure) that extends into the central recess of the hook-shaped structure. In a further example, plurality of retaining features 1311 and plurality of retaining features 1312 may each include a tab extending from the hook-shaped structure to catch with a mating feature of retainer 1301 (e.g., features 1341 and 1342, respectively. Because plurality of retaining features 1311 and plurality of retaining features 1312 are integrated as part of seal 1300, additional parts or clips need not be used to secure seal 1300 when installing in a vehicle.

The cross-sectional view of FIG. 13 is taken from a first location along seal 1300. The first location roughly corresponds to either section 1210 or 1230 of seal 1200 of FIG. 12, for example, where the seal would be arranged if wiper assembly 1390 were not in the way. The cross-sectional view of FIG. 14 is taken from a second location along seal 1300. The second location roughly corresponds to section 1220 of seal 1200 of FIG. 12, for example, where the seal accommodate (e.g., follow a path around) wiper assembly 1390, which is arranged along the otherwise simple seal path. Accordingly, a seal such as seal 1300 may follow any suitable path, accommodating any suitable number of components, systems, features, or otherwise regions that may cause the path to include changes in curvature, offsets, jogs, or otherwise become more complex.

In an illustrative example, referencing FIG. 12-14, an assembly may include a retainer (e.g., retainer 1301) and a window seal (e.g., seal 1300). The retainer may include an opening (e.g., recess 1391) that is configured to interface to a window of a vehicle. The window seal may include a molded shape having a first section configured to extend along an edge of the retainer (e.g., section 1210), a second section configured to extend along the edge of the retainer (e.g., section 1230), and a middle section (e.g., section 1220) arranged between the first section and the second section and offset outward from the first section and the second section. For example, the retainer may be configured to accommodate a wiper assembly (e.g., retainer 1301 and wiper assembly 1390), the first section and the second section may be arranged on opposite ends of the wiper assembly, and the middle section is offset around the wiper assembly. In a further example, the middle section may include a first transition (e.g., transition section 1221) that interfaces with the first section and extends from the first section to an offset distance, as well as a second transition (e.g., transition section 1222) that interfaces with the second section and extends from the second section to the offset distance (e.g., distancer 1225).

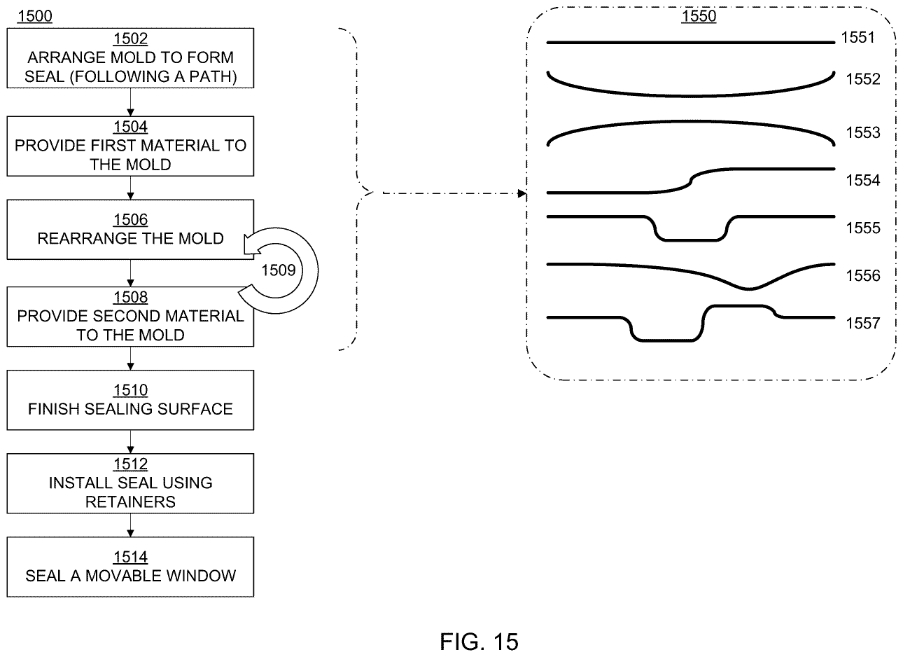

FIG. 15 is a flowchart of illustrative process 1500 for making and installing a seal, in accordance with some embodiments of the present disclosure. While a seal may be formed along a straight path, process 150 may allow for a seal to follow any suitable path, straight, curved, or with offsets or other complex aspects.

Step 1502 includes arranging a mold to form a seal. In some embodiments, the mold may include a mold core and a mold cavity configured to form a seal body (e.g., seal body 610 of seal 400, or seal body 910 of seal 500). In some embodiments, step 1502 includes arranging one or more sliders, lifters, or ejectors in preparation of receiving the first material at step 1504. For example, a seal body may include a plurality of first and second retaining features the extend into the central recess of a hook-shaped body (e.g., as illustrated in FIGS. 6 and 9-11), and step 1502 may include arranging a plurality of sliders to form each retaining feature. The seal may include openings, for example, through which the sliders may slide.

Step 1504 includes providing a first material to the mold. In some embodiments, the first material may include a first plastic. For example, the first plastic may include polypropylene or any other suitable plastic, and be formed as a single piece using the mold arranged at step 1502. The first material may be injected into the mold, for example, as part of a 2K-shot mold process. Once the first material is injected, one or more sliders may be removed, one or more lifters may be actuated, one or more ejectors may be activated, or a combination thereof, to allow removal or rearrangement of the molded part.

Step 1506 includes rearranging the mold. In some embodiments, another mold may be arranged, and may include another mold core and another mold cavity configured to form one or more lips, extensions, or other features of the seal (e.g., extensions 621, 622, and 623 of seal 400, or extensions 921 and 922 of seal 500). In some embodiments, step 1506 includes arranging one or more sliders, lifters, or ejectors in preparation of receiving the second material at step 1508. For example, a seal may include one or more lips extending outward from a hook-shaped body (e.g., as illustrated in FIGS. 6 and 9-11), and step 1506 may include arranging a mold to form the lips.

Step 1508 includes providing a second material to the mold. The second material may be, but need not be, different from the first material. In some embodiments, for example, the second material includes a thermoplastic vulcanize (TPV) or other suitable material or combination of materials, to form one or more sealing lips of the seal. The lips may be relatively flexible and compliant as compared to the seal body, and may be configured to seal against a vehicle structure, a window, or a combination thereof.

Loop 1509 corresponds to repeating steps 1506 and 1508 for the second material, additional materials, or any combination thereof, any suitable number of times. For example, in some embodiments, a plurality of lips may be formed, and each may be formed by one iteration of loop 1509. The material used at each iteration may be the same material or a different material as the previous forming/molding step. For example, steps 1506 and 1508 may be performed to form a first lip, and then may be repeated one or more times using the same material at loop 1509 to form one or more lips. In some embodiments, loop 1509 need not be performed. For example, more than one lip may be formed at a time using more than one mold, or otherwise a mold configured to form each lip at the same time. In a further example, a seal may include a single lip, and loop 1509 need not be performed.

Step 1510 includes finishing surfaces of the seal. In some embodiments, a surface material or finish may be added to one or more sealing lips. For example, material 624 of seal 400 or material 924 of seal 500 may be applied. The finishing may include adhering or otherwise bonding a sheet of material, coating a lip with a material (e.g., dipping, spraying, or painting a material that cures or dries), any other suitable process, or any combination thereof.

Step 1512 includes installing the seal using one or more retainers. In some embodiments, the seal is intended to be hidden from view as viewed from the vehicle exterior. In some embodiments, step 1512 includes mounting the seal to a flange (e.g., of or mounted to a plastic retainer) that includes complementing retention features. The seal includes retention features that may snap into or otherwise interface to the flange to secure the seal into position (e.g., without additional mechanical fasters or being merely held by friction, which could fail). To illustrate, the seal may be made of a first core plastic (e.g., polypropylene or other suitable material) and a second material to form the sealing lips (e.g., thermoplastic vulcanize (TPV) or other suitable material). For example, because the core (e.g., forming the body of the seal) is plastic, the retention features may be formed using a die, and the seal may include openings to de-core the retaining features during or after steps 1506-1508 and loop 1509 (e.g., by moving one or more sliders of the mold).

Step 1514 includes sealing a movable window. For example, once installed at step 1512, the seal may interface to a movable window. Referencing FIGS. 6 and 9-11, material 624 or material 924 may form a seal against the respective window, which may be configured to raise and lower or otherwise move along some trajectory. Because the seal is retained by one or more retaining features (e.g., a plurality of retaining features arranged on opposite sides of a flange), the seal remains substantially in place as the window moves.

Panel 1550 illustrates illustrative seal shapes, in accordance with some embodiments of the present disclosure. Illustrative shape 1551 follows a linear path. Illustrative shape 1552 follows a convex path (e.g., if arranged at the bottom of a window). Illustrative shape 1553 follows a concave path (e.g., if arranged at the bottom of a window). Illustrative shape 1554 follows a jogged path having straight, convex, and concave sections. Illustrative shape 1555 follows a path having an offset middle section. Illustrative shape 1556 follows a jogged path curving around a region. Illustrative shape 1557 follows a path having more than one offset section.

In some embodiments, process 1500 may allow the design and formation of seals to be simpler. For example, in some embodiments, rather than using extrusion and molding, steps 1502-1508 may include molding the seal as a 2K-shot part with embedded retention features and also interfacing to a vehicle structure (e.g., a plastic flange or retainer that the seal attaches to). For example, the seal (e.g., seal 400 or 500 of FIGS. 4 and 5, or any other suitable seal formed in accordance with the present disclosure) formed sing process 1500 may follow any simple or complex path and may still be hidden from view when installed in a vehicle.

In an illustrative example, a vehicle may include a tub or recess where a wiper or other obstacle sits in park position along a window (e.g., such as vehicle 100 having wiper tub 130, as illustrated in FIG. 1). The hidden wiper and tub may create a U-shape juggle that the seal needs to follow (e.g., as illustrated by seals 400 and 500) as the seal is hidden under a structure of the vehicle where the wiper is parked. This juggle in the path, along with the seal being hidden, may render design more difficult, especially for an extrusion process. For example, if extruded, the juggle may require molds on extruded sections of the seal to follow the path, and therefore the complexity of this seal increases (e.g., over a straight seal or otherwise a seal without a juggle or, jog, or offset). To illustrate, complexity and cost may increase if such a seal were formed using, instead of process 1500, three extrusion having two different designs and two molds (e.g., which might not be structural stable as they may only be rubber TPV, resulting in a seal where the extrusion is plastic such as polypropylene and the transitions are rubber TPV). Using process 1500, the seal may include a one-piece seal body (e.g., seal body 610 of seal 400 or seal body 910 of seal 500) that follows the path, includes retention features, and includes sealing lips extending outward to interface to sealing surfaces.

In another illustrative example, process 1500 may be used to form a window seal having a one-piece body. The one-piece body may include a first section including a first inner end, a second section comprising a second inner end, and a middle section arranged between the first section and the second section and at an offset from the first section and the second section (e.g., as illustrated by seal 400 or seal 500 of FIG. 4-5). The middle section includes a first transition coupled to the first inner end and a second transition coupled to the second inner end (e.g., as illustrated by section 420, which includes middle portion 424 and transitions 425 and 426, which are shaped to form an offset). In some embodiments, process 1500 may be used to form a one-piece body having a plurality of retaining features integrated as part of the one-piece body and configured to secure the window seal to a vehicle. In some embodiments, process 1500 is used to form a one-piece body further having a hook-shaped cross-section of a first material (e.g., formed at steps 1502 and 1504), a first lip including a second material (e.g., formed at steps 1506 and 1508 or otherwise loop 1509) extending outward from the hook-shaped cross section and configured to seal against the window, wherein the second material is more flexible than the first material, and a second lip including the second material (e.g., formed at steps 1506 and 1508 or otherwise loop 1509) extending outward from the hook-shaped cross section and configured to seal against a structure.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus comprising:
a window seal comprising a molded shape comprising:
a first section configured to extend along an edge of a window;
a second section configured to extend along the edge of the window; and
a middle section arranged between the first section and the second section and offset from the first section and the second section towards the edge of the window.

2. The apparatus of claim 1, wherein the middle section comprises:
a first transition that interfaces with a first end of the first section and curves away from the first end to offset the middle section; and
a second transition that interfaces with a second end of the second section and curves away from the second end to offset the middle section.

3. The apparatus of claim 1, wherein:
the window seal comprises a hook-shaped cross-section configured to interface to a retainer; and
the window seal comprises one or more retaining features configured to secure the window seal to the retainer.

4. The apparatus of claim 3, wherein the one or more retaining features comprise:
at least one first retaining feature arranged at a first end of the hook-shaped cross-section; and
at least one second retaining feature arranged at a second end of the hook-shaped cross-section.

5. The apparatus of claim 3, wherein the one or more retaining features comprise:
a plurality of first retaining features distributed along the first section, the middle section, and the second section; and
a plurality of second retaining features distributed along the first section, the middle section, and the second section.

6. The apparatus of claim 1, wherein the window seal comprises:
a first material forming a hook-shaped cross-section having a first wall that extends in a first direction, a second wall extending laterally from an end of the first wall, and a third wall that extends in a second direction opposite the first direction from the second wall, wherein the second wall extends between the first wall and the third wall.

7. The apparatus of claim 6, wherein the window seal comprises:
a first lip comprising a second material extending outward from the first wall and configured to seal against the window; and
a second lip comprising the second material extending outward from the second wall and configured to seal against a structure.

8. The apparatus of claim 6, wherein the window seal comprises:
a plurality of first retaining features comprising the first material and extending inward from an end of the third wall to engage a retainer to secure the window seal to the retainer; and
a plurality of second retaining features comprising the first material and extending inward from another end of the first wall to engage the retainer to secure the window seal to the retainer.

9. The apparatus of claim 8, wherein the plurality of first retaining features and the plurality of second retaining features are distributed along the first section, the middle section, and the second section.

10. The apparatus of claim 1, wherein:
the window seal is a one-piece seal; and
the middle section is offset from the first and second sections to accommodate a component arranged in-line with the first section and the second section.

11. The apparatus of claim 9, wherein the molded shape is formed as a single continuous piece using injection molding.

12. The apparatus of claim 1, wherein:
a path extends along the edge of the window along an outside surface of the window;
curvature of the path comprises only one of straight, convex, or concave;
the first section and the second section are aligned with the path; and
the middle section is offset from the path.

13. A window seal comprising:
a one-piece body comprising:
a first section comprising a first inner end;
a second section comprising a second inner end; and
a middle section arranged between the first section and the second section and at an offset from the first section and the second section, wherein the middle section comprises:
a first transition coupled to the first inner end; and
a second transition coupled to the second inner end, wherein the first transition and the second transition are shaped to form the offset.

14. The window seal of claim 13, wherein the one-piece body further comprises a plurality of retaining features configured to secure the window seal to a vehicle.

15. The window seal of claim 13, wherein the one-piece body further comprises:
a hook-shaped cross-section comprising a first material;
a first lip comprising a second material extending outward from the hook-shaped cross-section and configured to seal against a window, wherein the second material is more flexible than the first material; and
a second lip comprising the second material extending outward from the hook-shaped cross-section and configured to seal against a structure.

16. An assembly comprising:
a retainer comprising an opening configured to interface to a window of a vehicle; and
a window seal comprising a molded shape comprising:
a first section configured to extend along an edge of the retainer;
a second section configured to extend along the edge of the retainer; and
a middle section arranged between the first section and the second section and offset outward from the first section and the second section.

17. The assembly of claim 16, wherein:
the retainer is configured to accommodate a wiper assembly;
the first section and the second section are arranged on opposite ends of the wiper assembly; and
the middle section is offset around the wiper assembly.

18. The assembly of claim 16, wherein the middle section comprises:
a first transition that interfaces with the first section and extends from the first section to an offset distance; and
a second transition that interfaces with the second section and extends from the second section to the offset distance.

19. The assembly of claim 16, wherein the window seal further comprises a plurality of retaining features configured to secure the window seal to the retainer.

20. The assembly of claim 16, wherein the window seal further comprises:
a hook-shaped cross-section comprising a first material;
a first lip comprising a second material extending outward from the hook-shaped cross-section and configured to seal against the window, wherein the second material is more flexible than the first material; and
a second lip comprising the second material extending outward from the hook-shaped cross-section and configured to seal against a structure.
